(19) United States
(12) Patent Application Publication
(10) Pub. No.: US 2012/0242868 A1
(43) Pub. Date: Sep. 27, 2012

(54) IMAGE CAPTURING DEVICE

(75) Inventor: Jun Anzai, Kanagawa (JP)

(73) Assignee: PANASONIC CORPORATION, Osaka (JP)

(21) Appl. No.: 13/514,145

(22) PCT Filed: Dec. 6, 2010
(86) PCT No.: PCT/JP2010/007095

§ 371 Date: Jun. 6, 2012

(30) Foreign Application Priority Data
Dec. 7, 2009 (JP) 2009-277320

(51) Int. Cl. H04N 5/262; G06K 9/62; H04N 5/228

(52) U.S. Cl. 348/240.99; 348/222.1; 348/E05.031; 348/E05.055

(57) ABSTRACT

An image capturing device which image-captures a device to be controlled as a photographic subject and is controllable through a communication, includes an imaging unit that images an image of the photographic subject as a photographic subject image, a photographic subject recognition unit that recognizes the photographic subject from the photographic subject image, a photographic subject state determination unit that determines an image-captured state of the photographic subject in the photographic subject image, a menu generating unit that generates an operating menu by extracting a specific operation item from a plurality of operation items associated with the photographic subject according to the determination result in the photographic subject state determination unit, and a display unit that displays the operating menu generated by the menu generating unit.

### TECHNICAL FIELD

The present invention relates to an image capturing device which has an image capturing function and a communication function and is able to image-capture a device to be controlled as a photographic subject for control.

### BACKGROUND ART

Among image capturing devices such as a digital camera, there is an image capturing device which is able to perform an operation other than image-capturing on a display screen of a display unit of the image capturing device which displays a photographic subject image. For example, an image capturing device which includes a communication unit having a communication function such as a wireless LAN or Bluetooth (registered trademark) and is able to perform communication with a different device connected thereto through the communication unit to perform transmission and reception of captured image data or the like has been proposed (for example, refer to PTL 1). The device disclosed in PTL 1 displays a transmission destination device on a first display unit and displays a recorded image which is a transmission candidate on a second display unit, and then, transmits the recorded image to the transmission destination device displayed on the first display unit in a case where a transmission operation is performed for moving the recorded image from the second display unit to the first display unit. In this way, it is possible to simply and reliably set a transmission destination device which is a target among a plurality of transmission destination devices to transmit the recorded image.

Further, as another example in which an operation is possible in a display unit which displays a photographic subject image, PTL 2 discloses an image capturing device which displays an AF frame indicating the position of a focus region and a menu icon on a liquid crystal monitor and is able to perform a menu operation by movement of the AF frame.

### CITATION LIST

### Patent Literature

[PTL 1] JP-A-2007-235449
[PTL 2] JP-A-2009-100133

### SUMMARY OF INVENTION

### Technical Problem

Here, a case is considered where a target device which is a different device is displayed as a photographic subject image on a display screen of a display unit which displays a captured photographic subject image, and the target device is controlled by operation on the display screen. In this case, the image capturing device establishes communication with the target device which is a device to be controlled, which is image-captured, displayed and recognized as the photographic subject image, and transmits control information to the target device on the basis of an operation on the display screen. Even through the image capturing devices in the related art as described above, it is possible to display the captured image of the device to be controlled and a functional menu of the device to be controlled on the display screen of the display unit and to operate the functional menu. However, in a case where a general hierarchical menu is displayed using the image capturing devices in the related art, there are such problems that the display of the functional menu becomes complicated, the menu operation becomes difficult, and it is time-consuming for a user to search and select a necessary item, for example.

The invention is made in consideration of these circumstances, and the object thereof is to provide, in a case where a device to be controlled is image-captured as a photographic subject for control, an image capturing device which is able to display a suitable menu in accordance with the image-captured subject to be operable to thereby enhance the operability.

### Solution to Problem

According to an aspect of the invention, there is provided an image capturing device which image-captures a device to be controlled as a photographic subject and is controllable through communication, including: an imaging unit which images an image of the photographic subject as a photographic subject image; a photographic subject recognition unit which recognizes the photographic subject from the photographic subject image imaged by the imaging unit; a photographic subject state determination unit which determines an image-captured state of the photographic subject in the photographic subject image; a menu generating unit which generates an operating menu by extracting a specific operation item from a plurality of operation items associated with the photographic subject recognized by the photographic subject recognition unit according to the determination result in the photographic subject state determination unit; and a display unit which displays the operating menu generated by the menu generating unit.

According to this configuration, in a case where the device to be controlled is image-captured as the photographic subject for control, it is possible to generate an operating menu by extracting a suitable operation item according to the image-captured subject, to display the operating menu to be operable, and to enhance the operability.

In the above-described image capturing device according to the aspect of the invention, the photographic subject state determination unit includes a region determination unit which determines a region of the photographic subject, and the menu generating unit generates the operating menu according to the region determination result of the photographic subject in the photographic subject state determination unit.

According to this configuration, it is possible to generate the operating menu by extracting an operation item according to the region of the device to be controlled which is image-captured as the photographic subject, and to display the operating menu according to the region of the device to be controlled to be operable.

In the above-described image capturing device according to the aspect of the invention, the photographic subject state determination unit includes a distance determination unit, which determines the distance to the photographic subject, and the menu generating unit generates the operating menu according to the distance determination result of the photographic subject in the distance determination unit.

According to this configuration, it is possible to generate the operating menu by extracting an operation item according to the distance to the device to be controlled which is image-captured as the photographic subject, and to display the operating menu according to the distance to the device to be controlled to be operable.

In the above-described image capturing device according to the aspect of the invention, the photographic subject state determination unit includes a zoom determination unit which determines a zoom state of the photographic subject image, and the menu generating unit generates the operating menu according to the determination result of the zoom state in the zoom determination unit.

According to this configuration, it is possible to generate the operating menu by extracting an operation item according to the zoom state of the device to be controlled which is image-captured as the photographic subject, and to display the operating menu according to the zoom state of the device to be controlled to be operable.

In the above-described image capturing device according to the aspect of the invention, the imaging unit simultaneously image-captures the plurality of devices to be controlled, the photographic subject recognition unit recognizes the plurality of devices to be controlled which are simultaneously imaged by the imaging unit, and the menu generating unit generates an operating menu associated with the plurality of devices to be controlled which are recognized.

According to this configuration, it is possible to generate the operating menu by extracting an operation item associated with the plurality of devices to be controlled which are simultaneously imaged, and to display an operating menu having operations items relating to a common function, a cooperation function or the like of the plurality of devices to be controlled to be operable.

In the above-described image capturing device according to the aspect of the invention, the imaging unit image-captures the plurality of devices' to be controlled in a time-series manner, the photographic subject recognition unit recognizes each of the plurality of devices to be controlled which are imaged in a time-series manner by the imaging unit, and the menu generating unit is generates an operating menu associated with the plurality of devices to be controlled which are recognized.

According to this configuration, it is possible to generate the operating menu by extracting an operation item associated with the plurality of devices to be controlled which are imaged in a time-series manner, and to display an operating menu having operations items relating to a common function, a cooperation function or the like of the plurality of devices to be controlled to be operable.

In the above-described image capturing device according to the aspect of the invention, the menu generating unit generates the operating menu by extracting at least one of a common function and a cooperation function in the plurality of devices to be controlled as the specific operation item.

According to this configuration, it is possible to display an operating menu having operation items including at least one of the common function and the cooperation function in the plurality of devices to be controlled to be operable.

In the above-described image capturing device according to the aspect of the invention, the menu generating unit generates a menu associated with a first device to be controlled and a second device to be controlled by detecting a release operation in an image-captured state of the second device to be controlled after detecting a selection operation for the first device to be controlled.

According to this configuration, it is possible to generate the operating menu by designating the plurality of devices to be controlled by the selection operation and the release operation when generating an operating menu having associated operation items by image-capturing the plurality of devices to be controlled in a time-series manner.

In the above-described image capturing device according to the aspect of the invention, the menu generating unit generates a menu associated with a first device to be controlled and a second device to be controlled by detecting a focus release operation in an image-captured state of the second device to be controlled after detecting a focus operation for the first device to be controlled.

According to this configuration, it is possible to generate the operating menu by designating the plurality of devices to be controlled by the focus operation and the focus release operation when generating an operating menu having associated operation items by image-capturing the plurality of devices to be controlled in a time-series manner.

In the above-described image capturing device according to the aspect of the invention, the menu generating unit generates a menu associated with a first device to be controlled and a second device to be controlled by detecting an overlapped state of an image of the first device to be controlled and an image of the second device to be controlled which are imaged in a time-series manner in the photographic subject image.

According to this configuration, it is possible to generate the operating menu by designating the plurality of devices to be controlled by an operation of overlapping the images of the plurality of devices to be controlled when generating an operating menu having associated operation items by image-capturing the plurality of devices to be controlled in a time-series manner.

According to another aspect of the invention, there is provided a menu display device which is controllable through communication on the basis of a photographic subject image obtained by image-capturing a device to be controlled, including: a photographic subject recognition unit which recognizes a photographic subject from the photographic subject image; a photographic subject state determination unit which determines an image-captured state of the photographic subject in the photographic subject image; a menu generating unit which generates an operating menu by extracting a specific operation item from a plurality of operation items associated with the photographic subject recognized by the photographic subject recognition unit according to the determination result in the photographic subject state determination unit; and a display unit which displays the operating menu generated by the menu generating unit.

### Advantageous Effects of Invention

According to the invention, there can be provided an image capturing device in which in a case where the device to be controlled is image-captured as the photographic subject for control, it is possible to display a suitable item according to the image-captured subject to be operable, and to enhance the operability.

### BRIEF DESCRIPTION OF DRAWINGS

FIG. 1 is a block diagram illustrating a functional configuration of main units of an image capturing device according to a first embodiment of the invention.

FIG. 2 is a diagram illustrating a display example of a display screen of a display unit according to the first embodiment.

FIG. 3 is a flowchart illustrating an operating procedure relating to a menu display of a target device in the image capturing device according to the first embodiment.

FIG. 4 is a block diagram illustrating a functional configuration of main units of an image capturing device according to a second embodiment of the invention.

FIG. 5 is a diagram illustrating a display example of a display screen of a display unit according to the second embodiment.

FIG. 6 is a flowchart illustrating an operating procedure relating to a menu display of a target device in the image capturing device according to the second embodiment.

FIG. 7 is a block diagram illustrating a functional configuration of main units of an image capturing device according to a third embodiment of the invention.

FIG. 8 is a diagram illustrating a display example of a display screen of a display unit according to the third embodiment.

FIG. 9 is a flowchart illustrating an operating procedure relating to a menu display of a target device in the image capturing device according to the third embodiment.

FIG. 10 is a block diagram illustrating a functional configuration of main units of an image capturing device according to a fourth embodiment of the invention.

FIG. 11 is a diagram illustrating a display example of a display screen of a display unit according to the fourth embodiment.

FIG. 12 is a flowchart illustrating an operating procedure relating to a menu display of a target device in the image capturing device according to the fourth embodiment.

FIG. 13 is a block diagram illustrating a functional configuration of main units of an image capturing device according to a fifth embodiment of the invention.

FIG. 14 is a diagram illustrating a display example of a display screen of a display unit according to the fifth embodiment.

FIG. 15 is a flowchart illustrating an operating procedure relating to a menu display of a target device in the image capturing device according to the fifth embodiment.

### DESCRIPTION OF EMBODIMENTS

In embodiments described below, as an example of an image capturing device, a configuration example in which an image capturing function is provided in a mobile device such as a digital camera or a mobile phone will be described.

### First embodiment

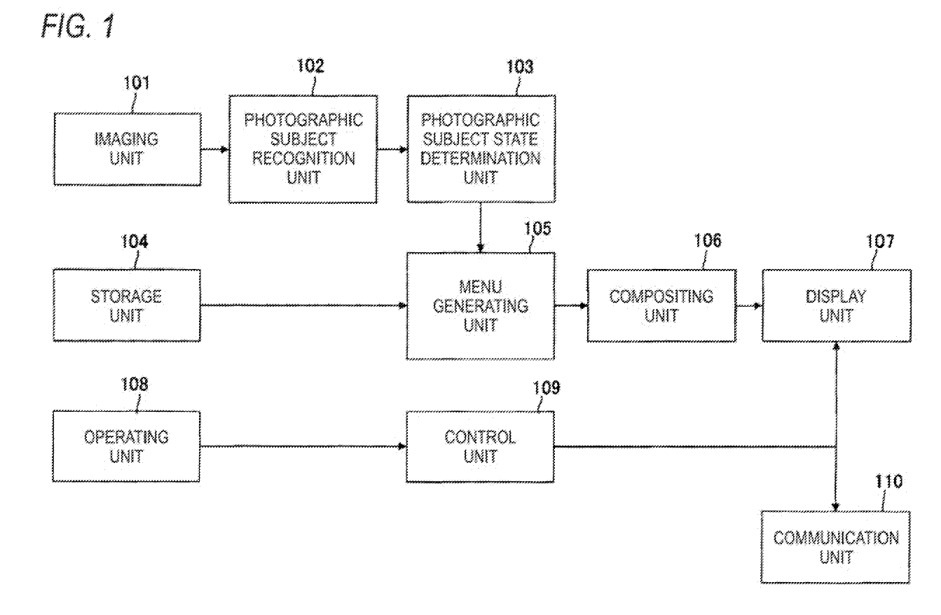

FIG. 1 is a block diagram illustrating a functional configuration of main units of an image capturing device according to the first embodiment of the invention. The image capturing device according to the first embodiment includes an imaging unit 101, a photographic subject recognition unit 102, a photographic subject state determination unit 103, a storage unit 104, a menu generating unit 105, a compositing unit 106, a display unit 107, an operation unit 108, a control unit 109, and a communication unit 110.

The imaging unit 101 includes an image capturing lens, an imaging element, an imaging element driver, an imaging signal processing unit, an AF driver, an AF driving unit, and the like, and captures a photographic subject image and generates and outputs a captured image signal indicating the photographic subject image. Here, the AF driver and the AF driving unit perform an auto-focus process of drive-controlling the image capturing lens on the basis of an AF control signal output from the control unit 109 or the like and allowing the photographic subject to enter a focused state. Further, the photographic subject which is image-formed by the image capturing lens is photo-electrically converted by the imaging element to output an imaging signal of the photographic subject, and generates the captured image signal by the imaging signal processing unit.

The photographic subject recognition unit 102 performs a recognition process of the photographic subject from the captured photographic subject image on the basis of the captured image signal output from the imaging unit 101. Here, in a case where image-capturing is performed using a device to be controlled as a photographic subject, the photographic subject recognition unit 102 recognizes the type or the like of a target device which is the device to be controlled and outputs photographic subject recognition information. The photographic subject state determination unit 103 determines an image-captured state of the photographic subject recognized by the photographic subject recognition unit 102. In the present embodiment, as an example of a determination function of the photographic subject state in the photographic subject state determination unit 103, a function of a region determination unit which determines a region of the target device which is the device to be controlled is used.

The recognition of the target device through the photographic subject recognition unit 102 and the determination of the region of the target device through the photographic subject state determination unit 103 may be realized by an image recognition process or the like using sample images. For example, images of the target device, the region thereof and the like are registered and characteristic points in photographic subject images are extracted to perform the image recognition process, to thereby discern the target device and the region. Alternatively, by assigning a distinguishable marker to each unit of the target device, and by recognizing the marker in the captured photographic subject image, it is possible to determine the target device and the region. Further, in a state where ID information about Bluetooth (registered trade mark) is recognized and the strength of an electric field intensity corresponding to the information is analyzed, the determination can be performed.

The storage unit 104 includes a non-volatile memory or the like, and stores menu information relating to a function or the like of the target device which is the device to be controlled. As the menu information, for example, information relating to a variety of operation items, such as an item for instructing an operation of the target device or an item for setting a function, is used. The menu information, recognition information about the target device and the region or the like may be locally stored in the main body of the image capturing device, or may be stored in another device such as a server to be appropriately obtained.

The menu generating unit 105 reads, on the basis of the determination result of the photographic state through the photographic subject state determination unit 103, corresponding menu information from the storage unit 104 to generate the operating menu according to the photographic subject state. Here, in the menu information, a specific operation item is extracted from a plurality of operation items which is associated with the recognized photographic subject to generate the operating menu. The compositing unit 106 synthesizes the photographic subject image captured by the imaging section 101 and a menu image of the operating menu generated by the menu generating unit 105 and outputs the result as a display image.

The display unit 107 includes a liquid crystal display, and displays a variety of displays such as images or characters. A photographic subject image for performing a preview of the photographic subject in image-capturing is displayed on a display screen of the display unit 107. In the present embodiment, the photographic subject image of the target device which is the device to be controlled and the menu image of the operating menu corresponding to the target device of the photographic subject are synthesized to be displayed.

The operation unit 108 includes an operation device such as a push button, a switch or a touch panel, and outputs an operation signal according to an operation instruction of a user. The control unit 109 performs control of the entire image capturing device, and performs a variety of controls including a display process of the display unit 107 and a communication process of the communication unit 110. The communication unit 110 performs communication such as wireless LAN or Bluetooth (registered trade mark), establishes a communication path to the target device which is the device to be controlled, and performs transmission and reception of various information such as data or commands, with respect to the connected target device. In the present embodiment, a case where wireless communication is performed with the target device is described.

When communication is performed between the image capturing device and the target device, the communication path is established on the basis of ID information about the recognized target device. For example, an identification code such as a QR code is disposed on a front surface of a housing of the target device, and then, the ID information about the target device is obtained by means for recognizing the identification code image-captured by the image capturing device to recognize the ID information or for recognizing an ID of the Bluetooth (registered trade mark), for example. Then, the strength of an electric field intensity corresponding to the information is analyzed, and then, the image capturing device is connected to a communication target device which includes the corresponding ID information. The image capturing device may be directly connected to the target device for communication or may be connected to the target device through a relay device such as a server for communication.

The photographic subject recognition unit 102, the photographic subject state determination unit 103, the menu generating unit 105, the compositing unit 106, and the control unit 109 include an MPU (Micro Processing unit), a DSP (Digital Signal Processor) and the like, and executes a predetermined program to perform a corresponding process, to thereby realize respective functions.

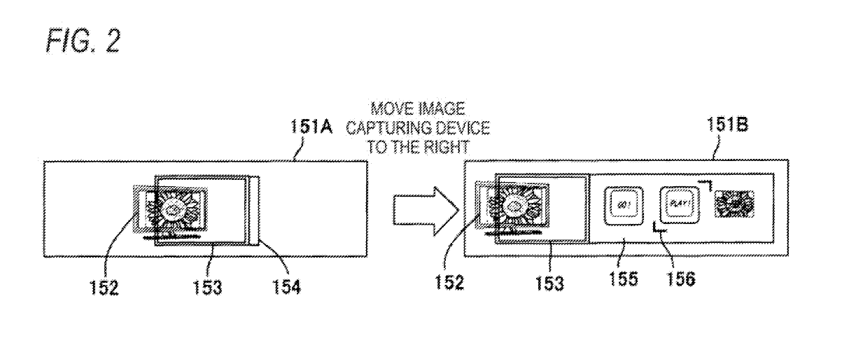

Next, an operation of the image capturing device according to the first embodiment will be described. FIG. 2 is a diagram illustrating a display example of a display screen of a display unit according to the first embodiment. In the first embodiment, an example is shown in which the region of the target device which is the device to be controlled is determined in the photographic subject image and a menu display according to the region determination result is performed.

The target device which is the device to be controlled is image-captured by the imaging unit 101, and the target device is displayed on a display screen of the display unit 107 as a photographic subject image. On a display screen 151A shown on the left side in FIG. 2 when the target device is selected, a state where a target device 152 (TV monitor in the example shown in the figure) of the photographic subject is disposed in an appropriately central portion of a display screen of preview display and a focus frame 153 is displayed in the central portion of the display screen is shown. In this case, the focus frame 153 is displayed on the target device 152. Further, on the right side of the focus frame 153, a menu bar 154 for enlarging and displaying a menu screen is disposed. Display control of the focus frame 153 is performed by a focus frame display control unit in the control unit 109. In this state, if a user performs a selection operation using the operation unit 108 by a half-press operation (focus operation) of a shutter button or the like, the target device 152 in the focus frame 153 is selected as the target device which is the device to be controlled. The focus frame described herein is an example, and thus, a selection frame is generally displayed. Further, the shutter button described herein is an example, and thus, an operation unit may be generally used.

Further, the type or the like of the selected target device is recognized by the photographic subject recognition unit 102, and the region of the recognized target device is determined by the position of the focus frame 153 by the photographic subject state determination unit 103. In the example of FIG. 2, the focus frame 153 is disposed on the right side portion of the TV monitor which is the target device 152, and in this case, it is determined that the target region image-captured as the photographic subject is the right side portion of the TV monitor. Next, the corresponding menu information is obtained from the storage unit 104 on the basis of the region determination result by the menu generating unit 105, and the operating menu which includes an operation item which is suitable for the region of the target device is generated as the operating menu according to the photographic subject state. For example, in a case where the portion of an operation switch is image-captured as the region of the TV monitor, an operating menu corresponding to the operation switch is generated. As another example, in a case where the target device is a notebook PC, when the portion of a keyboard is image-captured, an operating menu relating to the keyboard, for example, a soft keyboard or the like is generated, and when the portion of a display is image-captured, an operating menu relating to the display, for example, of the displayed content is generated. Alternatively, if the target device is a refrigerator, in a case where the portion of a freezing compartment is image-captured, a menu such as temperature adjustment of the freezing compartment is generated, and in a case where the portion of a cold room is image-captured, a menu corresponding to the cold room is generated.

When the operating menu is generated by the menu generating unit 105, the device state of the image capturing device may be determined by the device state determination unit in the control unit 109, and for example, the mode or shape of the device such as a display mode of a display screen of a display unit such as a vertically long display or a horizontally long display or an opened or closed state of a housing may be determined, to generate an operating menu corresponding to the device state. Further, in a case where content which is being reproduced in the target device, such as content which is is displayed on the TV monitor, is selected, an operating menu corresponding to the content which is a target is generated. As content reproduction, a variety of content reproductions, such as display of images, texts or the like, reproduction of sounds of music or the like, reproduction of moving images which includes images and sounds, or the like, are used as an example. Since it is discerned that the content is being generated by the photographic subject state determination unit 103, when communication with the target device which is the device to be controlled is established, information about content which is being reproduced can be obtained from the target device. Thus, it is possible to generate a corresponding menu only with sound content which is not capable of being image-captured. Further, in a case where the entire content is not present in the target device, for example, in streaming reproduction, it is possible to operate the content by obtaining obtainment destination information such as URL in addition to content information.

The menu information may be stored as menu information relating to a plurality of devices in the storage unit 104 in advance, and may be obtained by requesting menu information about the entire target device or the selected target region through communication with the identified target device through the communication unit 110 and by downloading the requested menu information from the target device. When the menu information is obtained, version information about the menu information is checked, and if the menu information is already stored by the storage unit 104, the menu information is not downloaded. The menu information may include additional information corresponding to the region of the target device, from which the menu information about the corresponding region according to the region determination result may be appropriately extracted. Further, the menu information and the state information about the target device which is the device to be controlled (for example, the channel number, volume or the like of a TV) may be simultaneously obtained, and may be displayed together when a corresponding menu is displayed. Further, in a case where the devices to be controlled such as mobile phones which are in the game are image-captured with each other, a menu relating to a competition mode may be displayed. In this case, in a usage state, this device is the image capturing device (control device) which performs menu creation, display, operation, control and the like, relating to a function or the like which cooperates with the other device, and the other device is the device to be controlled.

Further, a menu image of the generated operating menu and the photographic subject image are synthesized by the compositing unit 106, and the menu image and the photographic subject image are displayed on the display screen of the display unit 107 by an overlay display or the like. In the example shown in FIG. 2, a case is shown where as a menu bar is displayed on the image-captured region and a user moves the image capturing device to the right like a display screen 151B shown on the right side in FIG. 2 when a menu is displayed, a menu display 155 is displayed according to the movement operation. In this case, the target device 152 and the focus frame 153 on the display screen moves to the left with respect to the movement to the right of the image capturing device, and the menu bar 154 which is on the right side of the focus frame 153 extends to the right side, to display the menu display 155 on the right side of the target device 152. A selection cursor frame 156 is displayed in the menu display 155. In this state, if the user further moves the image capturing device to the right or to the left, the control unit 109 detects the movement of the photographic subject image by image recognition or the like, and moves the cursor frame 156 in accordance with the movement operation. Further, if the user performs a selection operation using the operation unit 108 by performing a release operation, a push operation or the like of the shutter button, an operation item which is disposed in the cursor frame 156 is selected at that time. By installing a touch panel in the display unit 107 and by touching a specific operation item in the menu image on the display screen by the user, the control unit 109 may detect the operation of the touch panel to perform selection of the operation item.

In a case where it is difficult to identify the region of the target device, for example, a menu bar indicating that a menu is present may be displayed in a plurality of locations (four edges or the like) of the focus frame, an operating menu corresponding to each of the plurality of portions may be associated with each menu bar, and the corresponding operating menu may be displayed according to the operation of the user. Here, if the user moves the image capturing device in a direction of a certain menu bar, the corresponding operating menu extends to be displayed. Alternatively, menu information which is finally operated is recorded in the storage unit 104, and in a case where it is difficult to identify the region, the finally operated menu may be displayed in the position which is previously stored.

If an operation item is selected in the menu image displayed in the display unit 107, instruction information about the corresponding operation item is transmitted to the target device through the communication unit 110 by the control unit 109, and an operation based on the instruction information is performed in the target device. Thus, the control of the target device is performed by the menu display and operation in the image capturing device.

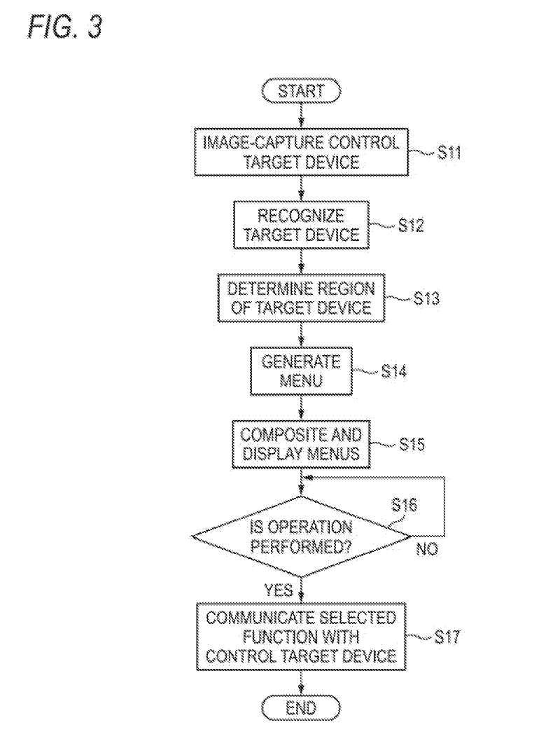

FIG. 3 is a flowchart illustrating an operating procedure relating to the menu display of the target device in the image capturing device according to the first embodiment. Firstly, the target device which is the device to be controlled is image-captured by the imaging device 101 (step S11). Here, the target device is displayed together with the focus frame on the display screen of the display unit 107 as the photographic subject image. Next, the target device which is captured in the photographic subject image on the display screen is recognized by the photographic subject recognition unit 102 (step S12), and the region of the focus frame in the photographic subject image is determined in the recognized target device by the photographic subject state determination unit 103 (step S13). Further, corresponding operating menu is generated on the basis of the region determination result of the target device by the menu generating unit 105 (step S14). Subsequently, the generated menu image and the photographic subject image are synthesized by the compositing unit 106, and the menu image of the operating menu and the photographic subject image are displayed on the display screen of the display unit 107 (step S15).

Here, the procedure enters a waiting mode of an operation input from the user (step S16), and then, in a case where there is an operation such as a movement operation of the above-mentioned image capturing device or a shutter button operation in the operation unit 108 and the displayed operation item is selected, instruction information relating to the function of the selected operation item is transmitted to the target device through the communication unit 110 (step S17). Thus, the operation corresponding to the operation item is performed in the target device.

As described above, according to the present embodiment, in a case where the device to be controlled is image-captured as the photographic subject for control, according to the image-captured state of the photographic subject, and according to the region of the target device which is the photographic subject in the above example, it is possible to generate an appropriate operating menu to be displayed on the display unit. For example, by displaying the operating menu corresponding to the region of the target device, it is possible to reduce such a burden that the user selects a hierarchical menu from an overview menu over a plurality of times. In this way, it is possible to display an appropriate menu to be operable according to the image-captured target in the present embodiment, to thereby enhance the operability.

### Second Embodiment

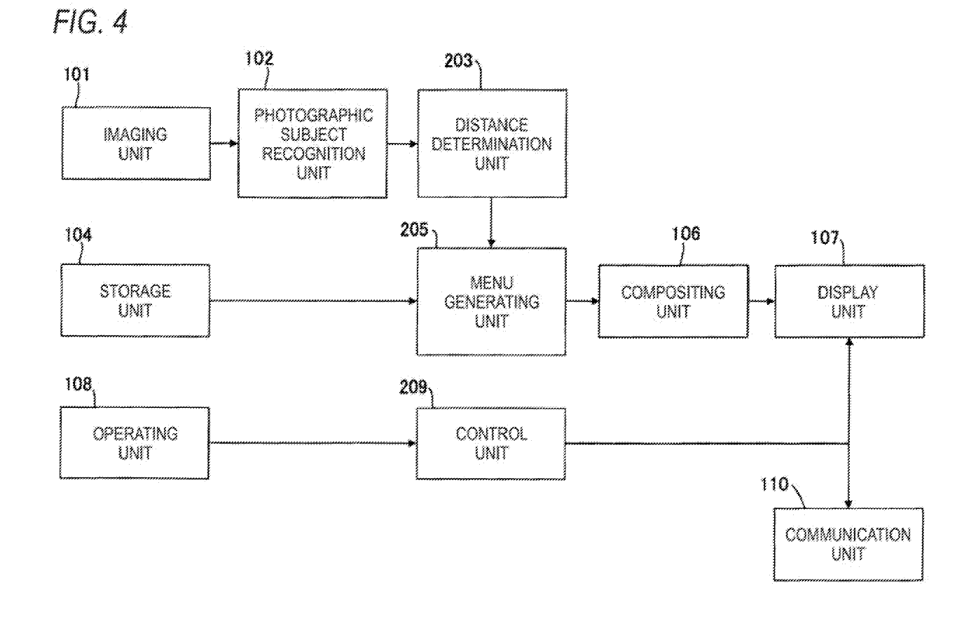

FIG. 4 is a block diagram illustrating a functional configuration of main units of an image capturing device according to a second embodiment of the invention. The image capturing device according to the second embodiment includes an imaging unit 101, a photographic subject recognition unit 102, a distance determination unit 203, a storage unit 104, a menu generating unit 205, a compositing unit 106, a display unit 107, an operation unit 108, a control unit 209, and a communication unit 110. The same reference numerals are given to the same components as in the first embodiment to omit description, and a different portion from the first embodiment will be mainly described.

The second embodiment is an example in which the distance from the image capturing device to a photographic subject (distance to a target device which is a device to be controlled) is determined and a corresponding operating menu according to the distance is generated, as another example relating to determination of the photographic subject state. In the second embodiment, instead of the photographic subject state determination unit 103 in the first embodiment, the distance determination unit 203 is provided. The distance determination unit 203 determines the distance between the photographic subject recognized in the photographic subject recognition unit 102 and the image capturing device. The determination of the distance to the photographic subject may be realized by a method of determining the distance by using distance measurement means for measuring the distance to the photographic subject from the size of the photographic subject in the captured image while storing the size information of the target device in advance, for example.

The menu generating unit 205 reads, on the basis of the determination result of the distance to the photographic subject through the distance determination unit 203, corresponding menu information from the storage unit 104 to generate an operating menu according to the distance. The control unit 209 controls the entire image capturing device, and controls the respective units including the distance determination unit 203 and the menu generating unit 205.

The distance determination unit 203, the menu generating unit 205, and the control unit 209 include an MPU, a DSP or the like in a similar way to the first embodiment, and perform a corresponding process by executing a predetermined software program, to thereby realize respective functions.

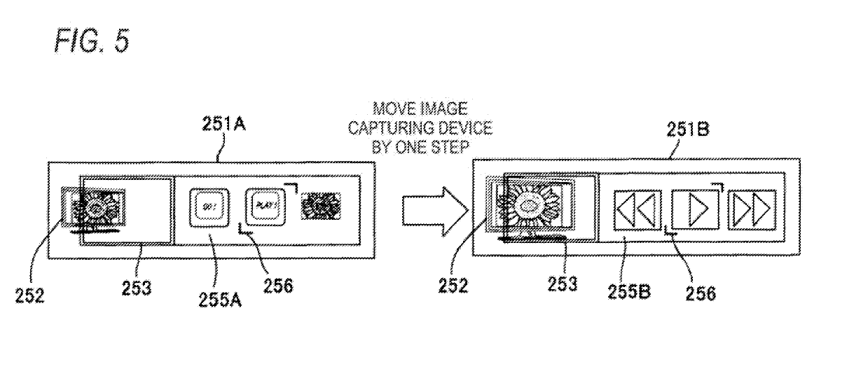

Next, an operation of the image capturing device according to the second embodiment will be described. FIG. 5 is a diagram illustrating a display example of a display screen of a display unit according to the second embodiment. In the second embodiment, an example is shown in which the distance to the target device which is the device to be controlled in the photographic subject image is determined and a menu display according to the distance determination result is performed.

The target device which is the device to be controlled is image-captured by the imaging device 101, and the target device is displayed on the display screen of the display unit 107 as the photographic subject image. Further, the type or the like of the selected target device is recognized by the photographic subject recognition unit 102, and the distance to the identified target device is determined by the distance determination unit 203 according to the size of the target device in the photographic subject image. Then, corresponding menu information is obtained from the storage unit 104 on the basis of the distance determination result of the photographic subject by the menu generating unit 205, and an operating menu which includes an operation item suitable for the distance to the target device is generated as the operating menu according to the photographic subject state.

For example, in a case where the distance to the target device is larger than a predetermined value, an overview menu (top menu of a hierarchical menu) is displayed, and in a case where the distance is smaller than the predetermined value, a detailed menu (individual menu of the hierarchical menu) is displayed. Here, as the distance is closer, a more detailed menu is generated. In a case where the detailed menu is generated, in combination of the menu generation based on the region determination according to the first embodiment, the operating menu corresponding to a region which is mainly image-captured such as a central portion of the photographic subject image (central portion or the like of the focus frame) is generated. Here, for example, in a case where content which is being reproduced in the target device, such as content which is displayed on the TV monitor, is image-captured, an operating menu corresponding to the content which is a target is generated. In a case where the distance to the photographic subject is determined periodically, for example, every predetermined time and the image capturing device is moved, the menu may be re-generated to be updated. In a case where it is difficult to identify the distance to the target device, for example, a top menu of the highest hierarchical menu may be generated to be displayed.

Further, a menu image of the generated operating menu and the photographic subject image are synthesized by the compositing unit 106, and the menu image and the photographic subject image are displayed on the display screen of the display unit 107 by an overlay display or the like. In the example shown in FIG. 5, on a display screen 251A when the menu is displayed in a first distance (distant distance) shown on the left side, an overview menu display 255A of an upper layer corresponding to the distant distance is displayed on the right side of a focus frame 253 in a target device 252 of the photographic subject on the display screen, in a similar way to FIG. 2. Further, in the menu display 255A, an operation item of content reproduction (PLAY) is selected by a selection cursor frame 256. If the user stores the image capturing device and moves ahead by one step to be close to the photographic subject from this state, like a display screen 2518 shown on the right side in FIG. 5 when the menu is displayed in a second distance (close distance), a detailed menu display 255B of a lower layer relating to content reproduction corresponding to the close distance is displayed. In the state of the menu display in FIG. 5, if the user moves the image capturing device to the right or to the left to move the cursor frame 256 according to this movement operation and performs a selection operation using the operation unit 108 by performing a release operation, a push operation or the like of the shutter button, an operation item which is disposed in the cursor frame 256 is selected at that time.

If an operation item is selected in the menu image displayed on the display unit 107, instruction information about the corresponding operation item is transmitted to the target device through the communication unit 110 by the control unit 209, and an operation based on the instruction information is performed in the target device. Thus, the control of the target device is performed by the menu display and operation in the image capturing device.

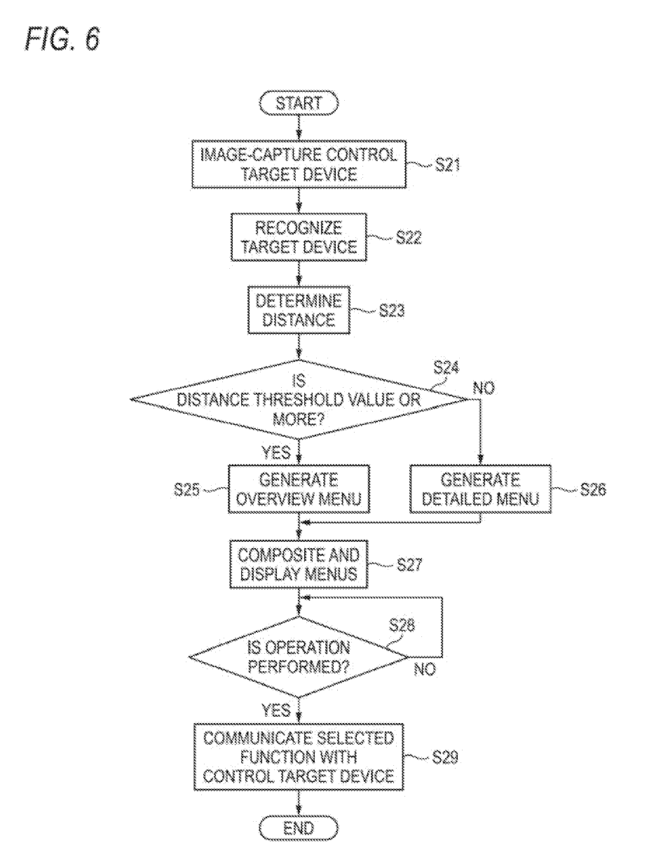

FIG. 6 is a flowchart illustrating an operating procedure relating to a menu display of a target device in the image capturing device according to the second embodiment. Firstly, the target device which is the device to be controlled is image-captured by the imaging device 101 (step S21). Here, the target device is displayed together with a focus frame on the display screen of the display unit 107 as a photographic subject image. Next, the image-captured target device in the photographic subject image on the display screen is recognized by the photographic subject recognition unit 102 (step S22), and the distance to the identified target device is determined by the distance determination unit 203 (step S23). Further, a corresponding operating menu is generated by the menu generating unit 205 on the basis of the distance determination result of the target device. Here, it is determined whether the distance to the target device is equal to or larger than a predetermined threshold value (step S24). If the distance is equal to or larger than the predetermined threshold value (the distance is distant), an overview menu is generated (step S25). On the other hand, if the distance to the target device is smaller than the predetermined threshold value (the distance is close), a detailed menu is generated (step S26). Subsequently, the generated menu image and the photographic subject image are synthesized by the compositing unit 106, and the menu image of the operating menu and the photographic subject image are displayed on the display screen of the display unit 107 (step S27).

Here, the procedure enters a waiting mode of an operation input from a user (step S28), and then, in a case where there is an operation such as a movement operation of the above-mentioned image capturing device or a shutter button operation in the operation unit 108 and the displayed operation item is selected, instruction information relating to the function of the selected operation item is transmitted to the target device through the communication unit 110 (step S29). Thus, the operation corresponding to the operation item is performed in the target device.

As described above, according to the present embodiment, in a case where the device to be controlled is image-captured as the photographic subject for control, according to the image-captured state of the photographic subject, and according to the distance to the target device which is the photographic subject in the above example, it is possible to generate an appropriate operating menu and to display the generated operating menu on the display unit.

### Third Embodiment

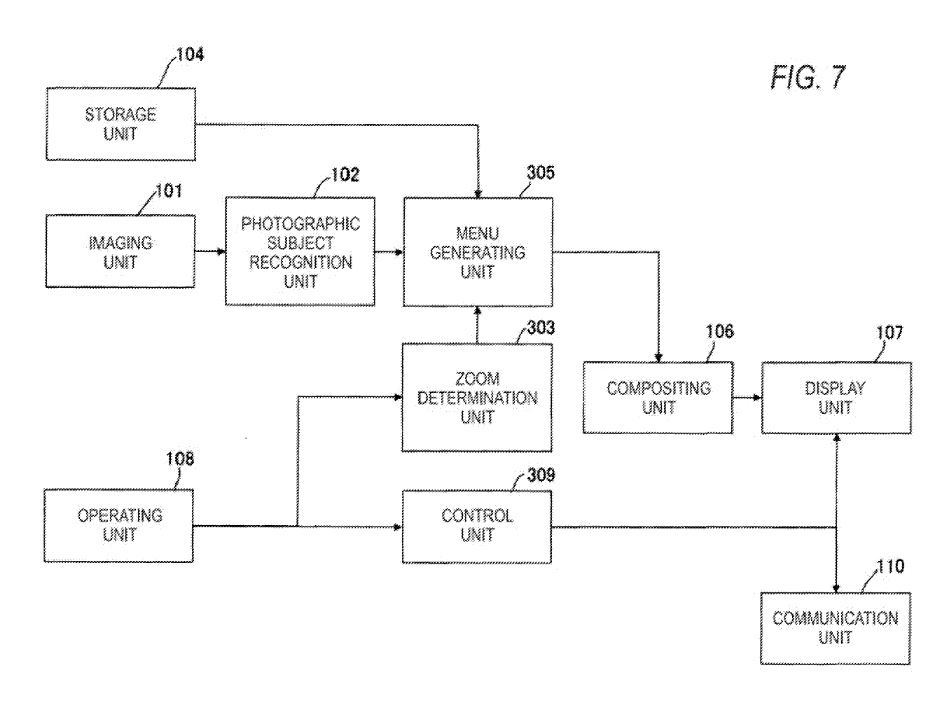

FIG. 7 is a block diagram illustrating a functional configuration of main units of an image capturing device according to a third embodiment of the invention. The image capturing device according to the third embodiment includes an imaging unit 101, a photographic subject recognition unit 102, a zoom determination unit 303, a storage unit 104, a menu generating unit 305, a compositing unit 106, a display unit 107, an operation unit 108, a control unit 309, and a communication unit 110. The same reference numerals are given to the same components as in the first embodiment to omit description, and a different portion from the first embodiment will be mainly described.

The third embodiment is a modification of the second embodiment, and is an example in which a zoom state of a photographic subject (the size of enlargement or contraction of a target device which is a device to be controlled) is determined and a corresponding operating menu according to the zoom state is generated, as another example relating to determination of the photographic subject state. In the third embodiment, instead of the distance determination unit 203 in the second embodiment, the zoom determination unit 303 is provided. The zoom determination unit 303 determines the zoom state of the photographic subject on the basis of a zoom operation input of an image-capturing lens from the operation unit 108, and determines the size of the target device in the photographic subject image. Here, the “zoom” is not only an optical zoom, but also may be a simple digital zoom process.

The menu generating unit 305 reads, on the basis of the determination result of the zoom state of the photographic subject image through the zoom determination unit 303, corresponding menu information from the storage unit 104 to generate an operating menu according to the zoom state. The control unit 309 controls the entire image capturing device, and controls the respective units including the zoom determination unit 303 and the menu generating unit 305.

The zoom determination unit 303, the menu generating unit 305, and the control unit 309 include an MPU, a DSP or the like in a similar way to the first embodiment, and perform a corresponding process by executing a predetermined software program, to thereby realize respective functions.

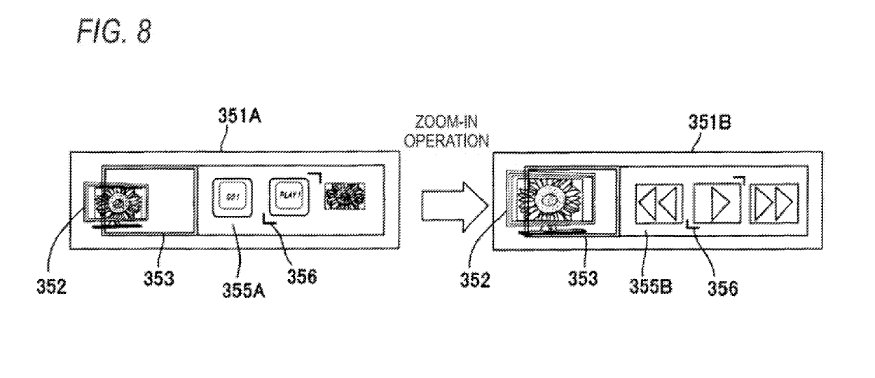

Next, an operation of the image capturing device according to the third embodiment will be described. FIG. 8 is a diagram illustrating a display example of a display screen of a display unit according to the third embodiment. In the third embodiment, an example is shown in which the zoom state in the photographic subject image (the size of the target device which is the image-captured device to be controlled, a zoom-in/zoom-out operation, or the like) is determined and a menu display according to the zoom state determination result is performed.

The target device which is the device to be controlled is image-captured by the imaging device 101, and the target device is displayed on the display screen of the display unit 107 as the photographic subject image. Further, the type or the like of the selected target device is recognized by the photographic subject recognition unit 102, and the zoom state of the image-captured photographic subject image is determined by the zoom determination unit 303. Then, corresponding menu information is obtained from the storage unit 104 on the basis of the zoom state determination result of the photographic subject image by the menu generating unit 305, and an operating menu which includes an operation item suitable for the zoom state of the target device is generated as the operating menu according to the photographic subject state.

For example, when a zoom-in operation of the photographic subject image is performed, a detailed menu (lower layer of a hierarchical menu) is displayed from the current time point, and when a zoom-out operation is performed, an abstract menu (upper layer of the hierarchical menu) is displayed from the current time point. Alternatively, in a case where the photographic subject image is zoomed out (the image-captured target device is smaller than the predetermined value), an overview menu (top menu of the hierarchical menu) is displayed, and in a case where the photographic subject image is zoomed in (the image-captured target device is larger than the predetermined value), a detailed menu (individual menu of the hierarchical menu) is displayed. Here, as the target device is enlarged, a more detailed menu may be generated. In a case where the detailed menu is generated, in combination of the menu generation based on the region determination according to the first embodiment, the operating menu corresponding to a region which is mainly image-captured such as a central portion of the photographic subject image (central portion or the like of the focus frame) is generated. Here, for example, in a case where content which is being reproduced in the target device, such as content which is displayed on a TV monitor, is image-captured, an operating menu corresponding to the content which is a target is generated.

Further, a menu image of the generated operating menu and the photographic subject image are synthesized by the compositing unit 106, and the menu image and the photographic subject image are displayed on the display screen of the display unit 107 by an overlay display or the like. In the display example shown in FIG. 8, on a display screen 351A when the menu is displayed in the first state (zoom-out state) shown on the left side, an overview menu display 355A of an upper layer corresponding to the zoom-out state is displayed on the right side of a focus frame 353 in a target device 352 of the photographic subject on the display screen, in a similar way to FIG. 2. Further, in the menu display 355A, an operation item of content reproduction (PLAY) is selected by a selection cursor frame 356. If the user operates the operation unit 108 to perform the zoom-in operation of the photographic subject from this state, like a display screen 351B shown on the right side in FIG. 8 when the menu is displayed in a second state (zoom-in state), a detailed menu display 355B of a lower layer relating to content reproduction corresponding to the zoom-in state is displayed. In the state of the menu display in FIG. 8, if the user moves the image capturing device to the right or to the left to move the cursor frame 356 according to this movement operation and performs a selection operation using the operation unit 108 by performing a release operation, a push operation or the like of the shutter button, an operation item which is disposed in the cursor frame 356 is selected at that time.

If an operation item is selected in the menu image displayed on the display unit 107, instruction information about the corresponding operation item is transmitted to the target device through the communication unit 110 by the control unit 309, and an operation based on the instruction information is performed in the target device. Thus, the control of the target device is performed by the menu display and operation in the image capturing device.

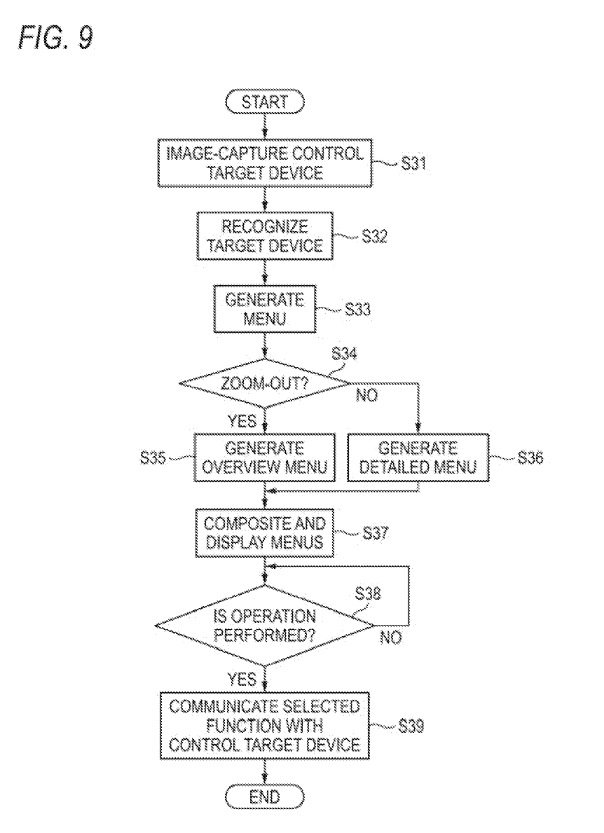

FIG. 9 is a flowchart illustrating an operating procedure relating to a menu display of a target device in the image capturing device according to the third embodiment. Firstly, the target device which is the device to be controlled is image-captured by the imaging device 101 (step S31). Here, the target device is displayed together with a focus frame on the display screen of the display unit 107 as a photographic subject image. Next, the image-captured target device in the photographic subject image on the display screen is recognized by the photographic subject recognition unit 102 (step S32), and a corresponding operating menu is generated by the menu generating unit 305 in the target device (step S33). Here, the zoom state of the photographic subject image is determined by the zoom determination unit 303, and an operating menu corresponding to the zoom state is generated by the menu generating unit 305 on the basis of the determination result. Here, it is determined whether the photographic subject image is in a zoom-out state (step S34), and if the photographic subject image is in the zoom-out state, an overview menu is generated (step S35). On the other hand, if the photographic subject image is in a zoom-in state (not in the zoom-out state), a detailed menu is generated (step S36). Subsequently, the generated menu image and the photographic subject image are synthesized by the compositing unit 106, and the menu image of the operating menu and the photographic subject image are displayed on the display screen of the display unit 107 (step S37).

Here, the procedure enters a waiting mode of an operation input from a user (step S38), and then, in a case where there is an operation such as a movement operation of the above-mentioned image capturing device or a shutter button operation in the operation unit 108 and the displayed operation item is selected, instruction information relating to the function of the selected operation item is transmitted to the target device through the communication unit 110 (step S39). Thus, the operation corresponding to the operation item is performed in the target device.

As described above, according to the present embodiment, in a case where the device to be controlled is image-captured as the photographic subject for control, according to the image-captured state of the photographic subject, and according to the zoom-in/zoom-out state of the photographic subject image in the above example, it is possible to generate an appropriate operating menu and to display the generated operating menu on the display unit.

### Fourth Embodiment

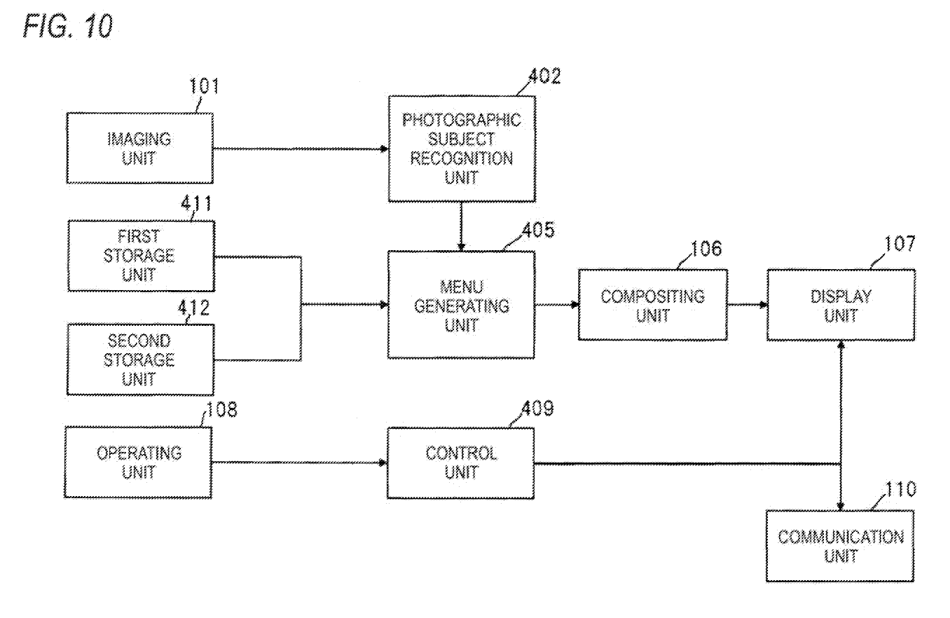

FIG. 10 is a block diagram illustrating a functional configuration of main units of an image capturing device according to a fourth embodiment of the invention. The image capturing device according to the fourth embodiment includes an imaging unit 101, a photographic subject recognition unit 402, a first storage unit 411, a second storage unit 412, a menu generating unit 405, a compositing unit 106, a display unit 107, an operation unit 108, a control unit 409, and a communication unit 110. The same reference numerals are given to the same components as in the first embodiment to omit description, and a different portion from the first embodiment will be mainly described.

The fourth embodiment shows a case where a plurality of target devices are image-captured to generate related operating menus. As a first example, there is an example in which the plurality of target devices are image-captured at the same time to generate a common function or a cooperation function. In the fourth embodiment, the first storage unit 411 and the second storage unit 412 which store individual menu information corresponding to the plurality of target devices are provided. The photographic subject recognition unit 402 recognizes the type or the like of a target device which is a device to be controlled on the basis of a captured image signal output from the imaging unit 101, and recognizes the plurality of target devices in the photographic subject image. The menu generating unit 405 reads, on the basis of the plurality of target devices recognized in the photographic subject recognition unit 402, menu information corresponding to the respective devices from the first storage unit 411 and the second storage unit 412 to generate an operating menu of the functions relating to the plurality of target devices. The control unit 409 performs control of the entire image capturing device, and performs control of the respective units including the photographic subject recognition unit 402 and the menu generating unit 405. In the following embodiment, an example is shown in which a menu of a common function or a cooperation function relating to two target devices as a plurality of target devices is generated, but this invention may be similarly applied to three or more target devices.

The photographic subject recognition unit 402, the menu generating unit 405, and the control unit 409 include an MPU, a DSP or the like in a similar way to the first embodiment, and perform a corresponding process by executing a predetermined software program, to thereby realize respective functions.

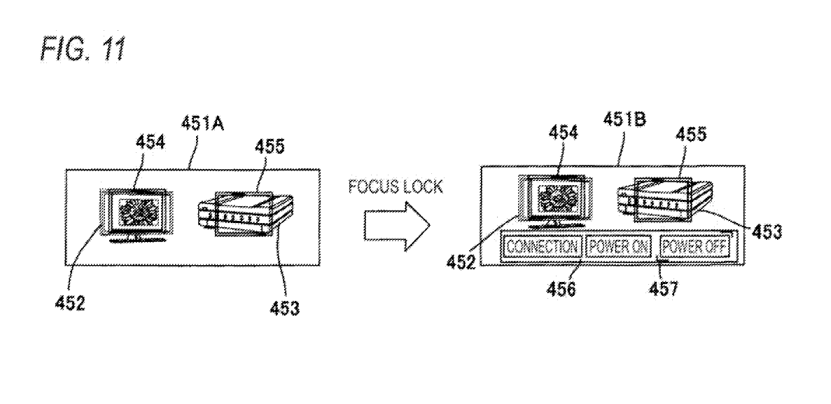

Next, an operation of the image capturing device according to the fourth embodiment will be described. FIG. 11 is a diagram illustrating a display example of a display screen of a display unit according to the fourth embodiment. In the fourth embodiment, an example is shown in which the plurality of target devices is recognized at the same time in the photographic subject image and a menu display of functions relating to these target devices is performed.

The plurality of target devices which are the devices to be controlled are image-captured at the same time by the imaging device 101, and the photographic subject images which include the plurality of target devices are displayed on the display screen of the display unit 107. On a display screen 451A shown on the left side in FIG. 11 when the target device is selected, two target devices 452 (TV monitor in the figure) and 453 (recorder in the figure) are disposed on the display screen of a preview display as the photographic subject, focus frames 454 and 455 are respectively displayed on the target devices. The display control of the focus frames 454 and 455 is performed by a focus frame display control unit in the control unit 409. In this state, if a user performs a selection operation using the operation unit 108, for example by a half-press operation (focus operation) of a shutter button, the target devices 452 and 453 in the focus frames 454 and 455 are selected as the target device which is the device to be controlled. When the plurality of target devices is selected, for example, a method is used in which the focus frame is displayed with respect to all the recognized target devices which are present in the photographic subject image and the user selects a necessary target device through the selection operation.

Further, the types or the like of the plurality of selected target devices are recognized by the photographic subject recognition unit 402. Then, menu information corresponding to the plurality of target devices is obtained from each of the first storage unit 411 and the second storage unit 412, and an operating menu in which operation items of the functions relating to the plurality of selected target devices is provided is generated by the menu generating unit 405. Here, when the operating menu is generated by the menu generating unit 405, a menu relating to a cooperation function, a menu from which is obtained by extracting a common function capable of controlling two target devices at the same time, for example, is generated from a first menu corresponding to the first target device and a second menu corresponding to the second target device. As the cooperation function, a connection or the like between two target devices may be used. In the shown example, a function of connecting a TV monitor and a recorder through communication means, and performing display, recording, reproduction, transmission, copy or the like of image content may be considered. Further, as the common function which is simultaneously controllable, power ON/OFF or the like may be used. For example, a function of turning on electric power of devices in the entire room or an image-captured device at a time may be considered. Further, at the time of content reproduction in the target device, an operating menu which includes operation items corresponding to target content is generated. In a case where connection is performed between target devices, the connection may be realized by obtaining ID information (IP address, URI or the like) from the first target device and transmitting the ID information to the second target device, and giving a connection request to the first target device or the second target device. Alternatively, since communication is completely established between both the first target device and the second target device and the image capturing device, respectively, the image capturing device may serve as a hub and information may be transmitted from the first target device to the second target device (or vice versa).

Further, a menu image of the generated operating menu and the photographic subject image are synthesized by the compositing unit 106, and the menu image and the photographic subject image are displayed on the display screen of the display unit 107 by an overlay display or the like. In the example shown in FIG. 11, a case is shown where a menu display 456 which is common in the plurality of devices is displayed on the lower side of the target devices 452 and 453, like a display screen 451B shown on the right side in FIG. 11 when a menu is displayed. A selection cursor frame 457 is displayed in the menu display 456. In this state, if the user moves the image capturing device to the right or to the left to move the cursor frame 457 in accordance with the movement operation and performs a selection operation using the operation unit 108 by performing a release operation, a push operation or the like of the shutter button, an operation item which is disposed in the cursor frame 457 is selected at that time. In the example shown in FIG. 11, power-off is selected. By installing a touch panel in the display unit 107 and by touching a specific operation item in the menu image on the display screen by the user, it is possible to select the operation item.

If the operation item is selected in the menu image displayed on the display unit 107, instruction information about a corresponding operation item is transmitted to the plurality of target devices through the communication unit 110 by the control unit 409, and an operation based on the instruction information in each of the target devices is performed. Thus, the plurality of target devices is controlled by the menu display and operation in the image capturing device.

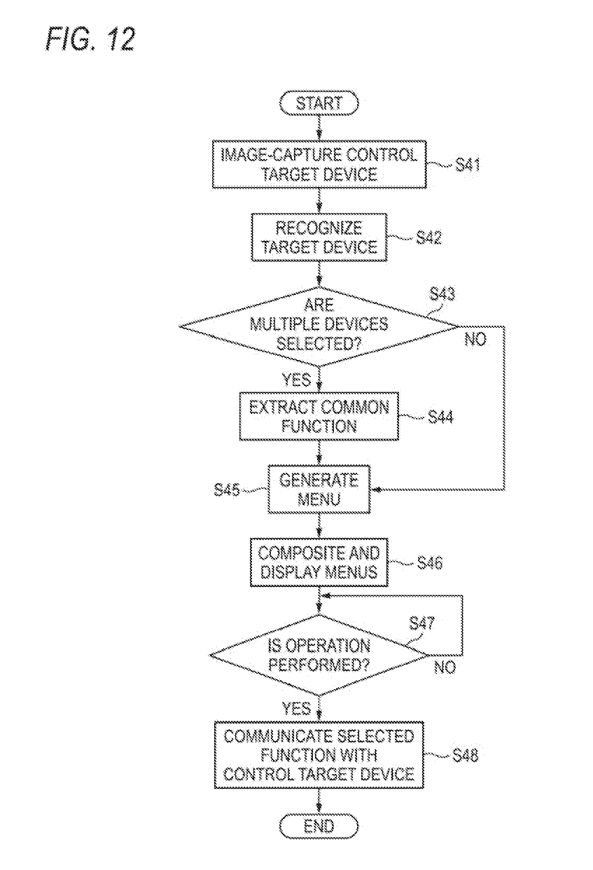

FIG. 12 is a flowchart illustrating an operating procedure relating to the menu display of the target device in the image capturing device according to the fourth embodiment. Firstly, the target device which is the device to be controlled is image-captured by the imaging device 101 (step S41). Here, the target device is displayed together with a focus frame on the display screen of the display unit 107 as a photographic subject image. Next, the image-captured target device in the photographic subject image on the display screen is recognized by the photographic subject recognition unit 402 (step S42). Further, it is determined by the menu generating unit 405 whether the plurality of target devices is selected (step S43), and in a case where the plurality of target devices is selected, a common function is extracted from menu information about the respective target devices (step S44), and an operating menu which includes operation items of the common function is generated (step S45). A cooperation function instead of the common function may be extracted to create the operating menu. On the other hand, in a case where the plurality of target devices is not selected, an operating menu corresponding to the corresponding target device is generated. Subsequently, the generated menu image and the photographic subject image are synthesized by the compositing unit 106, and the menu image of the operating menu and the photographic subject image are displayed on the display screen of the display unit 107 (step S46).

Here, the procedure enters a waiting mode of an operation input from the user (step S47), and then, in a case where there is an operation such as a movement operation of the above-mentioned image capturing device or a shutter button operation in the operation unit 108 and the displayed operation item is selected, instruction information relating to the function of the selected operation item is transmitted to the target device through the communication unit 110 (step S48). Thus, the operation corresponding to the operation item is performed in the target device.

As described above, according to the present embodiment, in a case where the device to be controlled is image-captured as the photographic subject for control, according to the image-captured state of the photographic subject, and according to the plurality of target devices which are image-captured at the same time as the photographic subject in the above example, it is possible to generate an appropriate operating menu and display the generated operating menu on the display unit.

### Fifth Embodiment

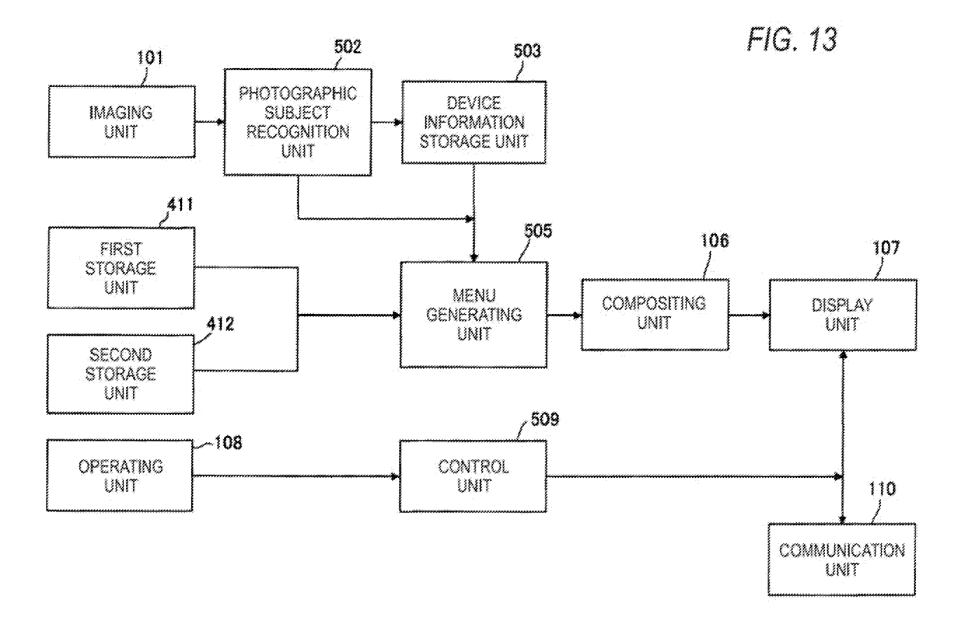

FIG. 13 is a block diagram illustrating a functional configuration of main units of an image capturing device according to a fifth embodiment of the invention. The image capturing device according to the fifth embodiment includes an imaging unit 101, a photographic subject recognition unit 502, a device information storage unit 503, a first storage unit 411, a second storage unit 412, a menu generating unit 505, a compositing unit 106, a display unit 107, an operation unit 108, a control unit 509, and a communication unit 110. The same reference numerals are given to the same components as in the first and fourth embodiments to omit description, and a different portion from the first and fourth embodiments will be mainly described.

The fifth embodiment is a modification of the fourth embodiment, and is a second example in a case where a plurality of target devices are image-captured to generate a related operating menu, which is an example in which the plurality of target devices are image-captured in a time-series manner to generate a common function menu or a cooperation function menu. In the fifth embodiment, in order to image-capture the plurality of target devices with the time difference, the device information storage unit 503 is provided. The photographic subject recognition unit 502 recognizes the type or the like of a target device which is a device to be controlled on the basis of a captured image signal output from the imaging unit 101, and outputs information about the recognized target device to the device information storage unit 503 as device information for storage. Here, the photographic subject recognition unit 502 recognizes the plurality of target devices in a time-series manner, on the basis of an operation instruction of a user. The menu generating unit 505 reads, on the basis of the recognition result in the photographic subject recognition unit 502 and the device information stored in the device information storage unit 503, menu information corresponding to the respective devices from the first storage unit 411 and the second storage unit 412 with respect to the plurality of recognized target devices, to generate an operating menu of functions relating to the plurality of target devices. The control unit 509 performs control of the entire image capturing device, and performs control of the respective units including the photographic subject recognition unit 502, the device information storage unit 503, and the menu generating unit 505.

The photographic subject recognition unit 502, the device information storage unit 503, the menu generating unit 505, and the control unit 509 include an MPU, a DSP or the like in a similar way to the first embodiment, and perform a corresponding process by executing a predetermined software program, to thereby realize respective functions.

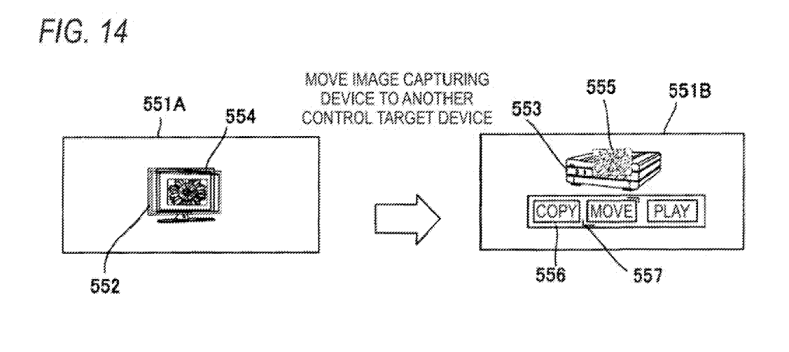

Next, an operation of the image capturing device according to the fifth embodiment will be described. FIG. 14 is a diagram illustrating a display example of a display screen of a display unit according to the fifth embodiment. In the fifth embodiment, an example is shown in which the plurality of target devices are recognized with the time difference in the photographic subject image and a menu display of the functions relating to these target devices is performed.

The target device which is the device to be controlled is image-captured by the imaging device 101, and the target device is displayed on the display screen of the display unit 107 as the photographic subject image. On a display screen 551A shown on the left side in FIG. 14 when the target device is selected, a first target device 552 (TV monitor in the figure) is disposed in an approximately central portion in a display image of a preview display as the photographic subject, and a focus frame 554 is displayed on the target device 552. The display control of the focus frame 554 is performed by a focus frame display control unit in the control unit 509. In this state, if the user performs a selection operation using the operation unit 108 by a half-press operation (focus operation) of a shutter button or the like, the target device 552 in the focus frames 554 is selected as a first target device which is a device to be controlled. Further, the type or the like of the selected target device is recognized by the photographic subject recognition unit 502, and information about the recognized device is stored in the device information storage unit 503. Subsequently, the menu information corresponding to the selected first target device 552 is obtained from the first storage unit 411 by the menu generating unit 505. The operation relating to focus is an example, and an operation of selecting or releasing a selection frame may be used.

Next, the user changes the image capturing position by moving the image capturing device to the right, to the left or the like in the focus state to image-capture a different target device, and thus, the second target device is displayed on the display screen of the display unit 107 in the photographic subject image. On a display screen 551B shown on the right side in FIG. 14 when a menu is displayed, a second target device 553 (recorder in the figure) is disposed in an approximately central portion in a display image as a photographic subject, and an image of the first target device 552 is displayed in a portion corresponding to a focus frame on the target device 553 by a semitransparent display 555. In this state, if the user performs a release operation using the operation unit 108 by a half-press operation release (focus release operation) of a shutter button or the like, the target device 553 in the focus frame of the semitransparent display 555 is selected as a second target device. Further, the type or the like of the selected target device is recognized by the photographic subject recognition unit 502, and menu information corresponding to the selected second target device is obtained through the second storage unit 412 by the menu generating unit 505.

Next, an operating menu which includes operation items of functions relating to these target devices 553 is generated by the menu generating unit 505, on the basis of the menu information corresponding to the plurality of selected target devices. For example, a menu relating to a cooperation function of two target devices, a menu from which a common function capable of controlling two target devices at the same time is extracted, or the like, is generated. Further, at the time of content reproduction in the target device, an operating menu which includes operation items corresponding to target content is generated. As an application example in a case where the plurality of target devices are image-captured with the time difference to generate a related operating menu, an operation in which a recorder and a TV monitor which are in different rooms are image-captured and selected, and video content stored in the recorder in a living room is displayed by the TV monitor in a bed room, or the like, may be considered. The content may be transmitted to the TV monitor through a home LAN or the like from the recorder, or may be stored once on the side of the image capturing device from the recorder and then may be transmitted to the TV monitor from the image capturing device. In the former case, it is assumed that the image capturing device maintains communication with the target device which is established in communication once.

Further, a menu image of the generated operating menu and the photographic subject image are synthesized by the compositing unit 106, and the menu image and the photographic subject image are displayed on the display screen of the display unit 107 by an overlay display or the like. On a display screen 5518 shown on the right side in FIG. 14 when a menu is displayed, a case is shown where a menu display 556 which is common in the plurality of devices is displayed on the lower side of the target devices 552 and 553. A selection cursor frame 557 is displayed on the menu display 556. In this state, if the user moves the image capturing device to the right or to the left to move the cursor frame 557 according to this movement operation and performs a selection operation using the operation unit 108 by performing a release operation, a push operation or the like of the shutter button, an operation item which is disposed in the cursor frame 557 is selected at that time. In the example shown in FIG. 14, “move” (content movement) is selected. Further, by installing a touch panel in the display unit 107 and by touching a specific operation item in the menu image on the display screen by the user, it is possible to select the operation item.

If the operation item is selected in the menu image displayed on the display unit 107, instruction information about a corresponding operation item is transmitted to the plurality of target devices through the communication unit 110 by the control unit 509, and an operation based on the instruction information is performed in each of the target devices. Thus, the plurality of target devices is controlled by the menu display and operation in the image capturing device.

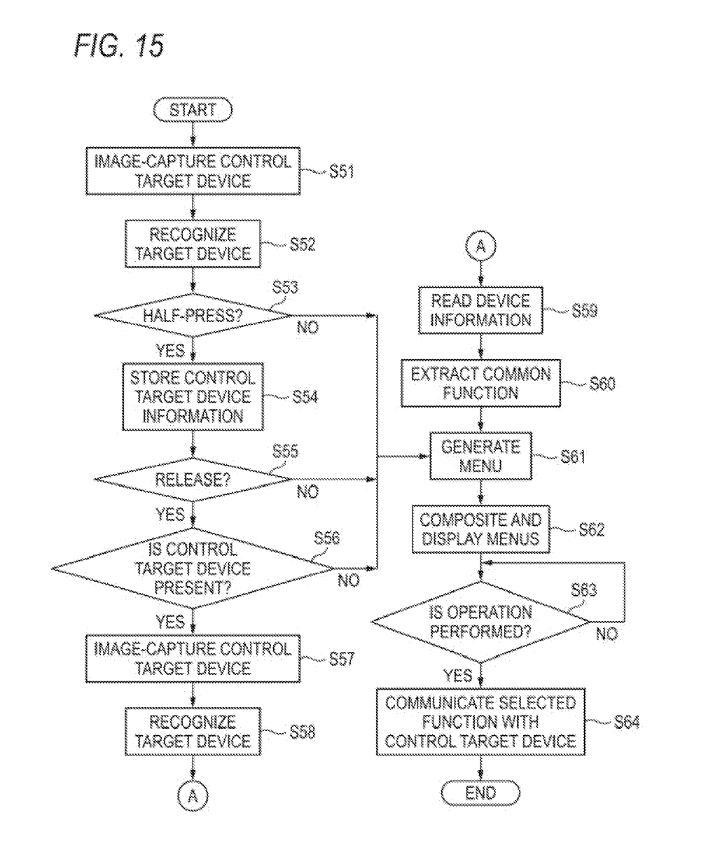

FIG. 15 is a flowchart illustrating an operating procedure relating to the menu display of the target device in the image capturing device according to the fifth embodiment. Firstly, the target device which is the device to be controlled is image-captured by the imaging device 101 (step S51). Here, the target device is displayed together with the focus frame on the display screen of the display unit 107 as the photographic subject image. Next, the image-captured target device in the photographic subject image on the display screen is recognized by the photographic subject recognition unit 502 (step S52). Further, it is determined by the control unit 509 whether the half-press operation of the shutter button by the user is present (step S53), and in a case where the focus operation through the half-press operation is present, device information about the recognized target device is stored in the device information storage unit 503 (step S54). Then, it is determined by the control unit 509 whether a release operation of the shutter button by the user is present (step S55), and in a case where the focus release operation through the release operation is present, it is determined whether another target device is present as a photographic subject (step S56). Here, in a case where the target device is present, the second target device is image-captured by the imaging unit 101 (step S57), and the target device in the photographic subject image on the display screen is recognized by the photographic subject recognition unit 502 (step S58).

Further, device information about the target device (first target device) which is stored in the device information storage unit 503 is read by the menu generating unit 505 (step S59), a common function is extracted from menu information of the respective first and second target devices (step S60), and an operating menu which includes operation items of the common function is generated (step S61). A cooperation function instead of the common function may be extracted to create an operating menu. On the other hand, in a case where the half-press operation of the shutter button is not present in step S53, in a case where the release operation of the shutter button is not present in step S55, and in a case where a different target device is not present in step S56, the operating menu corresponding to the firstly recognized target device is generated as it is. Subsequently, the generated menu image and the photographic subject image are synthesized by the compositing unit 106, and the menu image of the operating menu and the photographic subject image are displayed on the display screen of the display unit 107 (step S62). Instead of performing the menu generation by detection of the focus release operation in the image-captured state of the second target device after the focus operation for the first target device is detected as described above, by detecting an overlay state of the image of the first target device and the image of the second target device in the photographic subject image (or by detecting an overlay operation of images of two target devices), the menu generation may be performed.

Here, the procedure enters a waiting mode of an operation input from a user (step S63), and then, in a case where there is an operation such as a movement operation of the above-mentioned image capturing device or a shutter button operation in the operation unit 108 and the displayed operation item is selected, instruction information relating to the function of the selected operation item is transmitted to the target device through the communication unit 110 (step S64). Thus, the operation corresponding to the operation item is performed in the target device.

As described above, according to the present embodiment, in a case where the device to be controlled is image-captured as the photographic subject for control, according to the image-captured state of the photographic subject, and according to the plurality of target devices which is image-captured with the time difference as the photographic subject in the above example, it is possible to generate an appropriate operating menu and to display the generated operating menu on the display unit.

As described above, according to the respective embodiments, it is possible to generate the operating menu by extracting an appropriate operation item according to the image-captured state of the device to be controlled which is image-captured as the photographic subject, for example, according to the region, distance, zoom state or the like of the device to be controlled, and to display the operating menu according to the image-captured state to be operable. Further, in a case where the plurality of devices to be controlled is image-captured, it is possible to generate the operating menu by extracting operation items associated with the plurality of devices to be controlled, such as a common function, a cooperation function of the devices to be controlled. Accordingly, it is possible to display a suitable menu according to the state of the device to be controlled which is the image-capturing target to be operable, and to enhance the operability.

In the above respective embodiments, the case where the control unit (control device) is included in the image capturing device has been described, but the image capturing device and the control device may be configured by different devices, and may be connected to each other through wired or wireless communication means, to control the device to be controlled. In this case, the image capturing device which includes an imaging unit and the control device which includes a menu generating unit, a control unit and the like are configured by different separated devices. This control device may function as a menu display device which is capable of generating, displaying and the like a menu relating to the device to be controlled. Here, a display unit which displays an operating menu and an operation unit which performs a menu operation are not limited to a configuration in which these units are installed on the side of the control device, but may be installed on the side of the image capturing device, or may configured by a different device. As a specific example, a configuration is used in which the device to be controlled which is image-captured by a network camera is operated by a mobile phone or the like, for example. In the case of this configuration example, the network camera functions as the image capturing device and the mobile phone functions as the control device (menu display device). In this configuration example, a communication function with the device to be controlled is necessary on the side of the network camera, but in this regard, a general network camera may communicate with the device to be controlled using a network such as a LAN. According to the configuration shown in FIG. 1, the imaging unit 101 and the photographic subject recognition unit 102 may be connected to each other through a network.

The invention includes in a protection scope thereof a variety of modifications and applications made by those skilled in the art on the basis of the above description and known technologies without departing from the spirit and scope of the invention. Further, the respective components in the above-described embodiments may be arbitrarily synthesized in a range without departing from the spirit of the invention.

This application is based on Japanese Patent Application No. 2009-277320, filed on Dec. 7, 2009, the contents of which are incorporated herein by reference.

### INDUSTRIAL APPLICABILITY

According to the present invention, in a case where a device to be controlled is image-captured as a photographic subject for control, it is possible to display a suitable menu according to an image-captured target to be operable and to enhance the operability. Further, the invention is useful as an image capturing device or the like through a digital camera, a mobile phone device or the like which has an image capturing function and a communication function and is capable of image-capturing the device to be controlled as the photographic subject for control.

### REFERENCE SIGNS LIST

101 IMAGING UNIT
102, 402, 502 PHOTOGRAPHIC SUBJECT RECOGNITION UNIT
103 PHOTOGRAPHIC SUBJECT STATE DETERMINATION UNIT
104 STORAGE UNIT
105, 205, 305, 405, 505 MENU GENERATING UNIT
106 COMPOSITING UNIT
107 DISPLAY UNIT
108 OPERATING UNIT
109, 209, 309, 409, 509 CONTROL UNIT
110 COMMUNICATION UNIT
151A, 151B, 251A, 251B, 351A, 351B, 451A, 451B, 551A, 551B DISPLAY SCREEN
152, 252, 352, 452, 453, 552, 553 TARGET DEVICE
153, 253, 353, 454, 455, 554 FOCUS FRAME
154 MENU BAR
155, 255, 355, 456, 556 MENU DISPLAY
156, 256, 356, 457, 557 CURSOR FRAME
203 DISTANCE DETERMINATION UNIT
303 ZOOM DETERMINATION UNIT
411 FIRST STORAGE UNIT
412 SECOND STORAGE UNIT
503 DEVICE INFORMATION STORAGE UNIT
555 SEMITRANSPARENT DISPLAY

1. An image capturing device which image-captures a device to be controlled as a photographic subject and is controllable through a communication, comprising:
an imaging unit that images an image of the photographic subject as a photographic subject image;
a photographic subject recognition unit that recognizes the photographic subject from the photographic subject image imaged by the imaging unit;
a photographic subject state determination unit that determines an image-captured state of the photographic subject in the photographic subject image;
a menu generating unit that generates an operating menu by extracting a specific operation item from a plurality of operation items associated with the photographic subject recognized by the photographic subject recognition unit according to the determination result in the photographic subject state determination unit; and
a display unit that displays the operating menu generated by the menu generating unit.

2. The image capturing device according to claim 1, wherein the photographic subject state determination unit includes a region determination unit which determines a region of the photographic subject; and
wherein the menu generating unit generates the operating menu according to the region determination result of the photographic subject in the photographic subject state determination unit.

3. The image capturing device according to claim 1, wherein the photographic subject state determination unit includes a distance determination unit which determines the distance to the photographic subject; and
wherein the menu generating unit generates the operating menu according to the distance determination result of the photographic subject in the distance determination unit.

4. The image capturing device according to claim 1, wherein the photographic subject state determination unit includes a zoom determination unit which determines a zoom state of the photographic subject image; and
wherein the menu generating unit generates the operating menu according to the determination result of the zoom state in the zoom determination unit.

5. The image capturing device according to claim 1, wherein the imaging unit simultaneously image-captures the plurality of devices to be controlled, the photographic subject recognition unit recognizes the plurality of devices to be controlled which are simultaneously imaged by the imaging unit, and the menu generating unit generates an operating menu associated with the plurality of devices to be controlled which are recognized.

6. The image capturing device according to claim 1, wherein the imaging unit image-captures a plurality of devices to be controlled in a time-series manner;
wherein the photographic subject recognition unit recognizes each of the plurality of devices to be controlled which are imaged in the time-series manner by the imaging unit; and
wherein the menu generating unit generates an operating menu associated with the plurality of devices to be controlled which are recognized.

7. The image capturing device according to claim 5, wherein the menu generating unit generates the operating menu by extracting at least one of a common function and a cooperation function in the plurality of devices to be controlled as a specific operation item.

8. The image capturing device according to claim 6, wherein the menu generating unit generates a menu associated with a first device to be controlled and a second device to be controlled by detecting a release operation in an image-captured state of the second device to be controlled after detecting a selection operation for the first device to be controlled.

9. The image capturing device according to claim 6, wherein the menu generating unit generates a menu associated with a first device to be controlled and a second device to be controlled by detecting a focus release operation in an image-captured state of the second device to be controlled after detecting a focus operation for the first device to be controlled.

10. The image capturing device according to claim 6, wherein the menu generating unit generates a menu associated with a first device to be controlled and a second device to be controlled by detecting an overlapped state of an image of the first device to be controlled and an image of the second device to be controlled which are imaged in a time-series manner in the photographic subject image.

11. A menu display device which is controllable through a communication based on a photographic subject image obtained by image-capturing a device to be controlled, comprising:
a photographic subject recognition unit that recognizes a photographic subject from the photographic subject image;
a photographic subject state determination unit that determines an image-captured state of the photographic subject in the photographic subject image;
a menu generating unit that generates an operating menu by extracting a specific operation item from a plurality of operation items associated with the photographic subject recognized by the photographic subject recognition unit according to the determination result in the photographic subject state determination unit; and
a display unit that displays the operating menu generated by the menu generating unit.

12. The image capturing device according to claim 6, wherein the menu generating unit generates the operating menu by extracting at least one of a common function and a cooperation function in the plurality of devices to be controlled as a specific operation item.
